(19) United States
(12) Patent Application Publication
(10) Pub. No.: US 2008/0184320 A1
(43) Pub. Date: Jul. 31, 2008

(54) TVOD Processing Device And Computer KVM Switch Thereof

(76) Inventor: Tony Lou, Taipei (TW)

Correspondence Address: LIN & ASSOCIATES INTELLECTUAL PROPERTY, INC., P.O. BOX 2339, SARATOGA, CA, 95070-0339, US

(21) Appl. No.: 11/627,373

(22) Filed: Jan. 25, 2007

(51) Int. Cl. H04N 7/173

(52) U.S. Cl. 725/98

(57) ABSTRACT

A processing device and computer KVM switch for providing true video on demand, and which is mainly to provide true video information for many computing devices is proposed. The processing device is connected with the video display electrically through the video display interface, and is connected with the computing devices electrically through the computing device interface. The acquisition module in the microprocessor acquires the video information from the video display through the video display interface and then stores the information inside the video information database. When these computing devices are booted, they can acquire the true video information, which is not predetermined at random, corresponding to the video display from the video information database. At the same time, when the video display is being switched, it is not necessary that these computing devices to be rebooted so as to be informed of the video formats to be replaced.

### BACKGROUND OF THE INVENTION

1. Field of the Invention

The present invention relates to a processing device and computer KVM switch thereof, and in particular to a processing device and computer KVM switch thereof for providing true video on demand (TVOD).

2. The Prior Arts

Along with the increasingly greater device densities, and the abundance in quantities and varieties of computers, system management has become more and more difficult due to the increased complexities of the cabled networks. Thus, industries are eager to acquire an operation management system that can be adapted to a centralized control for alleviating computer room management difficulties, improving the work efficiency, and eliminating various human security risks in the operation management system. Therefore, the products that are related to KVM have been introduced accordingly.

A KVM (keyboard, video, and mouse) is also called a switch. A KVM switch system is referred to as the management device of a plurality of computer systems. A KVM allows a single keyboard, video display device, and mouse to be configured appropriately, and to perform switching to connect among different hosts under a multitude of methods by having a single person to interact with all the computers one at a time. The switch provides more space in addition to energy cost savings, also to make the mode for operation management of the computer room simpler for improved work efficiency in management maintenance, and to advance management safety and reliability.

According to the conventional KVM switch device, the cables connected between the control node (which is the operating node for users) and a plurality of computing device nodes (such as PCs) are mainly used for transmitting video signals (which are images that can be displayed on the video screen) and control signals (such as those sent out from input devices like keyboards and mouse). Therefore, when switching the KVM to the designated computing device node using the switch button (not illustrated in the figures) on the KVM, the users can view the images displayed on the display screen as are represented by the video signals which are received from the computing device node, and at the same time, remotely control the designated computing device node at long-distances using the keyboard and mouse directly.

Generally, the video display and the computing device (such as the PC) both have adopted the display data channel (DDC) for configuring formats (such as the resolutions) of the video signals to be adapted, and to use the video signals formats recorded in the extended display identification data (EDID) to perform the video formats communication. The EDID, which can also be referred to as video information format communication, is usually requested by the computing device, and then the EDID is responded by the video display. When the aforementioned communication is completed, the computing device can transmit the appropriate video formats (such as the resolutions) to the video display which are corresponding to the EDID information acquired from the video display. In other words, the user does not require adjusting the resolution of the output device to accommodate the connected PC. The device can reconfigure the two different resolutions automatically into an appropriate resolution.

However, according to a home-use KVM switch, a CAT5 KVM switch, and even a simple video switch, the video display and the computing device both transmit the related video signals through the KVM switch or the video switch indirectly. In order to overcome this problem, both the conventional KVM or video switch provides a simplified communication mode (for example, only resolutions predetermined for the video displays and the computing devices are provided), which have created many problems and even to the point that images cannot be displayed at all on the screen.

Some manufacturers have applied simplified detecting methods for overcoming some of the problems. Basically, the first booted computing device can acquire the true EDID information directly from the video display. However, the EDID information is not being stored and provided for other computing devices; thus, the other computing devices have remained to only acquire the simulated predetermined EDID. However, if the video display is replaced in midway, the computing device can only be rebooted and the communication is to be redone. However, sometimes even rebooting the device cannot help to successfully provide the aforementioned communication.

### SUMMARY OF THE INVENTION

A primary objective of the present invention is to provide a processing device and a computer KVM switch thereof for handling true video on demand, by acquiring the EDID from the video display and the computing device respectively in real time/on demand, and transmitting the EDID to the computing device and the video display in due time.

Based on the objective above, the processing device and computer KVM switch thereof for providing true video on demand in this present invention can mainly provide true video information for a plurality of computing devices. The processing device of the present invention is connected to the video display electrically through the video display interface, and is connected to these computing devices electrically through the computing device interface. The acquisition module in the microprocessor acquires the video information from the video display through the video display interface and stores the video information in the video information database. When these computing devices are booted, they can acquire the true video information, which is not established at random from the video information database, but is corresponding to the video display; and when the video display is replaced or switched, it is not necessary that these computing devices are to be rebooted so as to be informed of the video format that is replaced into.

### BRIEF DESCRIPTION OF THE DRAWINGS

The present invention will be apparent to those skilled in the art by reading the following detailed description of a preferred embodiment thereof, with reference to the attached drawings, in which:

FIG. 1 is a schematic block diagram showing a processing device for providing true video on demand in accordance with the present invention; and

FIG. 2 is a schematic block diagram showing the provisioning of true video on demand in accordance with the present invention.

### DETAILED DESCRIPTION OF THE PREFERRED EMBODIMENT

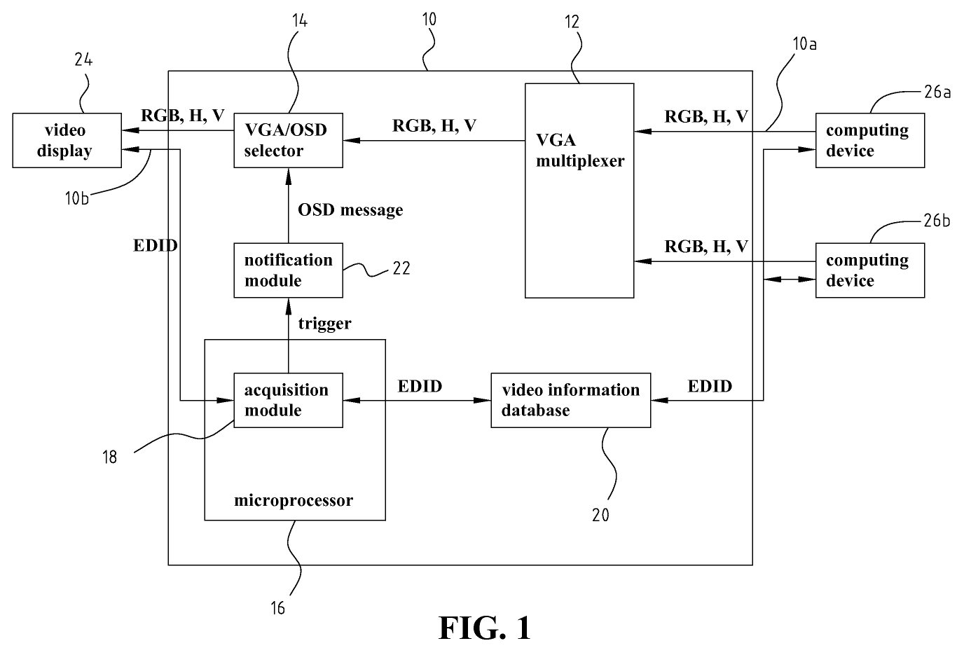

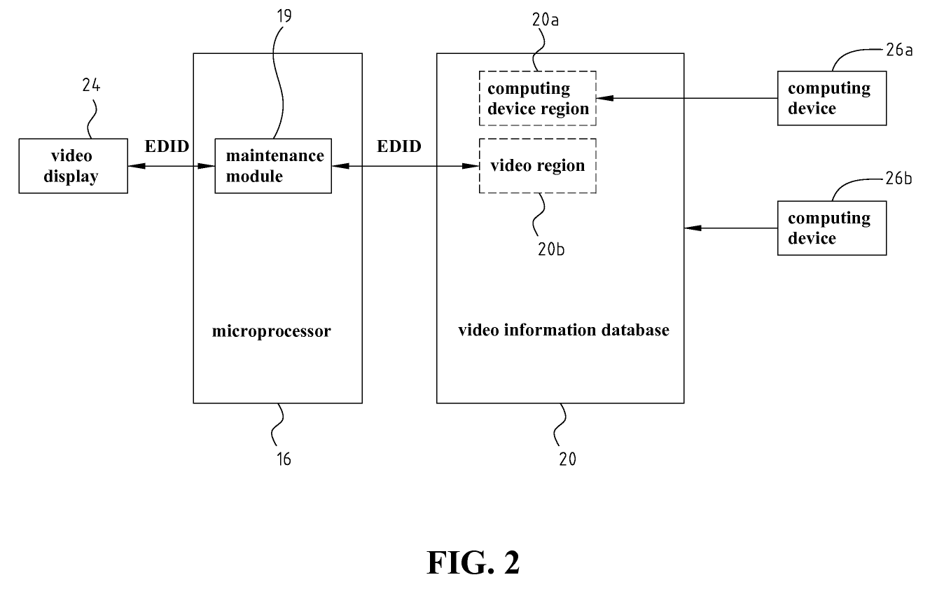

Referring to FIG. 1, it is a schematic block diagram showing the processing device for providing true video on demand. As shown in FIG. 1, the processing device 10 mainly includes a plurality of conventional video processing components (a VGA multiplexer 12, a VGA/OSD selector 14, and a microprocessor 16). The microprocessor 16 further includes an acquisition module 18 and a video information database 20. The video information database 20 can be of a single nonvolatile memory, an array nonvolatile memory (as shown in FIG. 2), or other media capable of storing adequate amount of information. The processing device 10 can connect with the video display 24 electrically through the video display interface 10b and connect with these computing devices 26a-26b electrically through the computing interface 10a. One thing worthy of paying attention is that the video display 24 is not limited to a single unit, but can be more than one, and the corresponding quantity is dependent on the number of users for surveillance.

The processing device 10 (one or more) for providing the true video on demand provides the video information, the extended display identification data (EDID), for a plurality of the computing devices 26a-26b on demand. In order to transmit the true EDID to the computing devices 26a-26b, the acquisition module 18 in the processing device 10 stores the EDID in the video information database 20 after acquiring the EDID. There is a plurality of video information stored in the video information database 20; and each EDID includes the resolution at least. When these computing devices 26a-26b are booted, or when the users are switched to the predetermined computing device, the true EDID corresponding to the video display 24, which is no longer the resolution predetermined at random or the resolution of the first video acquired from the video information database 20, so as to output the image whose resolution is supported by and is suitable to the video display 24.

Thus, if the video display 24 is being replaced midway, the users can watch by means of the microprocessors 16 on demand and to acquire the new EDID again to update the data in the video information database 20. And then, comparing the new EDID with the original EDID using the microprocessor 16, the notification module 22 is triggered to display information using on screen display (OSD) on the video display 24 for informing the users to update the video formats of the computing devices 26a-26b. The video display 24 that has the video being updated is configured with the computing devices 25a-26b to adapt to output the appropriate video images/pictures. Below, the computing device 26a and the video display 24 are taken as examples for illustrating the method for the aforementioned comparison determination, and the complete configuration of the video information database 20.

Referring to FIG. 2, it is a schematic block diagram showing the provisioning of true video on demand in accordance with the present invention. As shown in FIG. 2, the computing device 26a, the video display 24, and the video information database 20 can be further divided into a computing device region 20a and a video region 20b. The computing device region 20a stores the video information used currently or previously in these computing devices 26a-26b. When these computing devices 26a-26b are booted, they can automatically acquire the video information. The video region 20b stores the video information of the video display 24. When the video display 24 is booted, the video information is updated automatically.

In regards to the video display 24 and the computing device 26a, although they can share the same memory region for storing the EDID, however, when the video display 24 and the computing device 26a are updating the EDID at the same time in the memory region, the occurrence of the updating conflict phenomenon are readily observed. In order to avoid this phenomenon, the computing device region 20a and the video region 20b are developed especially for avoiding the errors thereby leading to improved fault tolerance capability.

For example, after the video display 24 is booted, the acquisition module 18 in the microprocessor 16 can acquire the EDID from the video display 24 and to store the EDID in the video region 20b. Because at the beginning there is no information in the computing device region 20a, the maintenance module 19 can replace the video information in the video region 20b by the video information in the computing device region 20a when the corresponding set of video information are found to be different in the computing device region 20a and in the video region 20b. Thus, the computing device 26a can acquire the video information from the video display 24 successfully and transmit the video picture with the correct or suitable resolution. When the video display 24 is being replaced by another video display having different display capabilities, the maintenance module 19 is to assess whether the video information in the video region 20b and in the computing device region 20a are the same at predetermined time intervals, and to detect whether the video display 24 has been switched, and to replace again the video information in the computing device region 20a. Nevertheless, the computing device region 20a can not automatically reobtain this video information, but is to inform the users to execute update procedure through the notification module 22.

Furthermore, the processing device in this present invention is still applied in the computer KVM switch. The processing device additionally comprises a keyboard interface (for coupling with the keyboard electrically) and a mouse interface (for coupling with the mouse electrically).

Although the present invention has been described with reference to the preferred embodiment thereof, it is apparent to those skilled in the art that a variety of modifications and changes may be made without departing from the scope of the present invention which is intended to be defined by the appended claims.

What is claimed is:

1. A processing device for providing true video on demand, and providing an extended display identification data (EDID) from a video display to a plurality of computing devices on demand, comprising:
a video display interface, connecting to the video display electrically;
a computing device interface, connecting to the computing devices electrically;
a video information database, for storing a plurality of video information; each video information comprising a resolution at least; and
an acquisition module, for acquiring the video information from the video display through the video display interface and storing the video information inside the video information database, wherein the computing devices acquire the true video information corresponding to the video from the video display from the video information database for displaying the video information after the computing devices are booted.

2. The processing device for providing true video on demand as claimed in claim 1, wherein the video information database is of a single nonvolatile memory, or an array nonvolatile memory.

3. The processing device for providing true video on demand as claimed in claim 1,
wherein the processing device further comprises:
the video information database further comprising:
a video region, for storing the video information of the video display and automatically updating the video information when the video display is booted;
a computing device region, for storing the video information currently or previously used, and automatically acquiring the video information when one of the computing devices is booted;
a maintenance module, for replacing the video information in the computing device region by the video information in the video region when the video information are not the same according to the corresponding set of video information in the video region and in the computing device region.

4. The processing device for providing true video on demand as claimed in claim 1,
wherein the processing device further comprises:
a notification module, triggered by the acquisition module, for displaying information using on screen display (OSD) on the video display for informing the users to update the video formats of the computing devices.

5. The processing device for providing true video information as claimed in claim 3, wherein the maintenance module is to assess whether the video information according to the corresponding set in the video region and in the computing device region are the same at a plurality of predetermined time intervals.

6. A computer KVM switch for providing true video information on demand and video information of a video display for a plurality of computing devices on demand, comprising:
a keyboard interface, connecting to a keyboard electrically;
a mouse interface, connecting to a mouse electrically;
a video display interface, connecting to the video display electrically;
a computing device interface, connecting to the computing devices electrically;
a video information database, storing a plurality of video information, and each video information comprising a resolution at least; and
an acquisition module, for acquiring the video information from the video display through the video display interface, and storing the video information in the video information database, wherein the true video information according to the video display is able to be acquired from the video information database after the computing devices are booted.

7. The computer KVM switch for providing true video on demand as claimed in claim 6, wherein the video information database is of a single nonvolatile memory, or an array nonvolatile memory.

8. The computer KVM switch for providing true video information on demand as
claimed in claim 6, wherein the computer KVM switch further comprises:
the video information database, further comprising:
a video region, for storing the video information of the video display and automatically updating the video information when the video display is booted;
a computing device region, for storing the video information of the computing devices and automatically acquiring the video information when one of the computing devices is booted;
a maintenance module, for replacing the video information in the computing device region by the video information in the video region when the video information are not the same according to the corresponding set of video information in the video region and in the computing device region.

9. The computer KVM switch for providing true video on demand as claimed in claim 6, wherein the computer KVM switch further comprises:
a notification module, triggered by the acquisition module, for displaying information using on screen display (OSD) on the video display for informing users to update the video formats of the computing device.

10. The computer KVM switch for providing true video on demand as claimed in claim 8, wherein the maintenance module is to assess whether the video information according to the corresponding set in the video region and in the computing device region are the same at a plurality of predetermined time intervals.

11. The computer KVM switch for providing true video on demand as claimed in claim 6, wherein the computer KVM switch is of a home-use KVM switch or a CAT5 KVM switch.
